(19) United States
(12) Patent Application Publication
(10) Pub. No.: US 2026/0142823 A1
(43) Pub. Date: May 21, 2026

(54) AUTHENTICATION SYSTEM AND METHOD FOR WINDOWS SYSTEMS

(71) Applicant: L'Garde, Inc., Reno, NV (US)

(72) Inventors: Herbert W. Spencer, III, Grass Valley, CA (US); Jeffrey Long, Reno, NV (US); Carson Hawley, Grass Valley, CA (US); Christopher M. Canfield, Santa Clarita, CA (US)

(21) Appl. No.: 19/298,964

(22) Filed: Aug. 13, 2025

Related U.S. Application Data
(63) Continuation of application No. PCT/US24/15864, filed on Feb. 14, 2024.
(60) Provisional application No. 63/485,002, filed on Feb. 14, 2023.

(51) Int. Cl. H04L 9/32

(52) U.S. Cl. CPC H04L 9/3226; H04L 9/3213

(57) ABSTRACT

Exemplary embodiments of the process and systems described herein include accessing a electronic device that is not connected to an authentication server by a user authentication by a multi-factor authentication using a mobile device as one factor and by either authenticating to the mobile device with a biometric or with knowledge as the second factor; wherein an encrypted code is transferred to the mobile device and decrypted by the mobile device, then using the decryption of the encrypted code to access an encrypted token on the computer that allows access to the computer by the user.

### PRIORITY

The instant application claims priority as a continuation to International Application Number PCTUS2415864, filed Feb. 14, 2024, which claims priority to U.S. Provisional Patent Application No. 63/485,002, filed Feb. 14, 2023, titled Authentication System and Method for Windows System, each of which is incorporated by reference in its entirety herein.

### BACKGROUND

Microsoft's Windows application permits multi-factor authentication, called WindowsMFA. WindowsMFA allows for passwordless multi-factor authentication to support Microsoft Windows operating systems. Remote access to computers, particularly to servers using Microsoft remote desktop, has vulnerabilities when only a password is used for access and even if a second factor is used requiring one pass code or an authentication approval. For example, the security measures have been proven to be subject to social engineering attacks.

Currently, Microsoft does not provide remote desktop multi-factor authentication. Given the configuration of the Windows system, providing a remote authentication system that permits log in into a Windows machine that works with Windows MFA is difficult. Therefore, there is no known multi-factor authentication systems or methods that are currently available to a remote windows server.

Applicant of the instant application has a patent application pending for SSH multi-factor authentication to Linux machines and other devices that can use a pluggable authentication module. International Patent Publication WO2021/041566 is incorporated herein in its entirety.

Applicant of the instant application has a patent application pending for the online remote access of a Windows machine using multi-factor authentication. U.S. patent application Ser. No. 18/506,106, filed Nov. 9, 2023, is incorporated herein in its entirety.

Another instance of a multi-factor authentication method includes having the user possess a FIDO key that can be plugged into the device, such as through the USB port to provide authentication and access. However, these devices that are physically attached to the device or do not have independent uses other than to authenticate a user on a device may be coupled to the device, such as being left in the USB or otherwise attached to or stored with the device to facilitate easy access when authentication is desired. Therefore, a device separate from the device to be authenticated that has other uses so that it will be separated from the device and not stored in the same way are desirable.

Most multi-factor authentication systems require access with or communication to a remote server to confirm the authentication credentials. However, there are many instances in which access to a remote server is not available. A user will still need to be authenticated on these devices to maintain security of the device. In these cases, security is usually sacrificed and multi-factor authentication is not conducted; instead, relying simply on login credentials or other single factor methods that are available and stored on the device directly.

### SUMMARY

Exemplary embodiments described herein include systems and methods for a credential provider (CP) to provide a user access to an electronic device when the electronic device does not have communication access to a network that permits remote authentication.

Exemplary embodiments described herein include systems and methods for a credential provider (CP) to provide a user access to an electronic device when the electronic device does not have direct communication with another device in order to still provide multiple factor authentication with the other device.

The absence of a connection of the electronic device removes the use of an authentication server that is conventional in current authentication systems. However, embodiments described herein may be used to maintain a desired level of security through the use of multi-factor authentication (MFA). In a desired configuration, a first factor authentication is from a separate electronic device in the possession of the user, while a second factor authentication may be any of a knowledge factor or biometric factor such as finger print, facial scan, password, key, pin, etc. or any combination thereof.

### DRAWINGS

FIG. 1 illustrates an exemplary method 100 of providing multi-factor authentication of a device that is offline and not in communication with an authentication server.

FIG. 2 illustrates an exemplary method 200 of providing multi-factor authentication of a device that is offline and not in communication with an authentication server.

FIGS. 3A-3C illustrates an exemplary successful login to a machine that results in the creation and storage of data used for an offline login.

FIGS. 4A-4B illustrates an embodiment of the current invention where a user logs into a host machine while the machine is offline where the user has previously logged in while online to create data used in an offline login.

FIG. 5 shows an embodiment of the current invention where an installed credential provider creates and stores values for use in an offline login on a host machine.

FIG. 6. shows an embodiment of the current invention where the credentials needed to log into a host machine are retrieved and used by an installed credential provider for offline login while the host machine is offline.

FIGS. 7A-7D shows an embodiment where an installed credential provider can be used during an online login to create data to be used during an offline login.

FIGS. 8A-8D shows an embodiment of the current invention where data for offline login is used to allow a user to log into a host machine when the host machine is offline.

FIGS. 9A-9F shows an embodiment of the current invention where an account on a user's mobile device 1001 (a second device) is attempted to be accessed.

FIGS. 10A-10D shows an embodiment of the current invention where a user's mobile device is online 1101.

FIG. 11 illustrates an exemplary embodiment in which a user desires to access a first device remotely from a third device.

FIG. 12 illustrates an exemplary embodiment in which a user desires to access a first device directly. The system uses an authentication server (fourth device) as described herein to confirm that access is permitted through information received from a second device, where each of the first, second, and fourth devices are separate electronic devices.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Access to computers today is mainly through a username and password or pin credential. In some cases, additional factors are added such as Fido key, or biometric. Applicants of the instant application recently filed a patent application where a Microsoft Windows Personal Computer (PC) is authenticated with a credential provider using a mobile device such as a mobile phone that has a built in biometric connected to an authentication server through the internet. The PC is able to connect to the authentication server through the internet. However, if the PC does not have access to the authentication server, the user cannot be authenticated, and access cannot be granted to the user. Exemplary embodiments of the present disclosure are directed at systems and methods to address the situation when either the PC or mobile device or both devices do not have a connection to the authentication server. Exemplary embodiments still preferably maintain a desired level of security through multi-factor authentication by requiring the user to possess something that is independent of the PC and to which the user logging into the PC can authenticate with a biometric or knowledge factor (or other authentication method).

A Windows Personal Computer (PC) is shown and described as the device to which a user is attempting to access. The personal computer is understood to be a computer having memory, processing, input/output devices connected thereto, or a combination thereof. Any computing device may fall within the scope of a personal computer, such as, without limitation, a desktop, laptop, mobile electronic device, etc. The Windows Personal Computer is a personal computer or computing device that runs the Windows operating system and uses the Windows system to gain access to the computing device.

The use of a mobile phones as the object possessed by the user is particularly useful because it is a device the user keeps close control of. However, given the additional uses of the mobile phone, a user is not likely to keep the phone connected to or stored with the PC. Although the preferred embodiment described herein include a mobile phone, other mobile electronic devices are also contemplated as available interfaces for additional authentication in place of the mobile phone according to embodiments described herein. For example, tablets, smart watches, or other smart devices may also be used in place of or in addition to the mobile phone shown and described herein.

Exemplary embodiments of a multi-factor authentication system and method for a Windows PC can use an authentication server and a private/public key pair. In this instance, the private key may be securely stored on a mobile electronic device. The secure access to the private key may be through an authentication barrier, such as a knowledge factor (password, pin, etc.), or a user biometric (face or fingerprint scan). For higher security requirements, both biometric and knowledge factor authentication may be required. The key pair may be unique to the user's device. The mobile electronic device may be separate from the PC and may be a possession of the user that has uses other than authentication of the user. In an exemplary embodiment, the mobile electronic device is a user's mobile phone. The mobile electronic device is therefore unlikely to be kept or continuously connected to the PC.

In an exemplary embodiment, the mobile electronic device has an application (non-transitory machine readable instructions stored in memory and executed by the processor) that is accessed by the user through an authentication log in interface (such as a biometric, user name/password, etc.). The application may then be used according to embodiments described herein to share the public key with a PC or Windows device and/or use its private key according to embodiments described herein.

Exemplary embodiments comprise storing the private key on the mobile electronic device and generating a public key for sharing with the PC in order to authenticate the user. The public key may be stored on the PC to allow access of the user. The public key of the user may be received by the PC through different methods, or a combination of methods depending on the connection of the PC. For example, the PC may receive a code from the user that is provided to the user from the mobile electronic device, the PC may scan an image or code from the mobile electronic device, the PC may communicate wired or wirelessly with the mobile electronic device to obtain the public key. The PC may receive the public key during an online authentication attempt with an authentication server. The PC may receive the public key during a registration process with an authentication server. The PC may receive the public key in any combination of ways as provided herein, not all options are required to be present.

In an exemplary embodiment, the PC comprises an application that is stored in memory as non-transitory machine instructions that are executed by a processor of the PC. When the instructions are executed by the processor, the PC is configured to receive the public key of the mobile electronic device of the user. The application or PC may be configured to receive the public key in any combination of ways. For example, the PC may be configured to scan a presentation of the public key that is provided on the display screen of the mobile electronic device. An application can be written to run on the PC that scans a presentation of the public key presented on the screen of the mobile device, such as in a quick response (QR) code or other visual medium. When the instructions are executed by the processor, the PC may be configured to receive a user input of the public key, such as by the user entering an alpha-number entry on a keyboard. The public key could be presented on the mobile electronic device and then manually imputed into the PC using an application designed to accept an input and store the public key on the PC. The presentation of the public key may be alpha-numeric, quick response (QR) code, bar code, image, etc. As another example, a terminal application could be used or the Windows Shell. Another way is to transfer the public key in an OpenID Connect (OIDC) Identification (ID) token or claim or as part of a user information query when a credential provider uses OIDC to communicate with an authentication server.

Exemplary embodiments described herein may overcome or minimize issues that are present with the Fast Identification Online (FIDO) Universal Serial Bus (USB) keys and windows Hello certificate-based logins. For the FIDO system, a USB key may be plugged into the USB port that has a public-private key pair. The public key may be registered with the computer but usually requires a pin to log in. However, the USB key often remains plugged into the computer and is not removed when the computer is shut down. The system therefore essentially results in the same password credential authentication that is susceptible to attack. When the key is not removed, the FIDO key pair is no longer a second factor. In the Microsoft Windows certificate-based system, the certificate is not removable. In this case, the pin is also one factor for logging in, except when physical access of the PC is controlled.

Exemplary embodiments of the systems and methods described herein minimizes these issues. A public key is registered with a PC, and the key pair's private key is stored securely on the user's mobile device. The mobile device may be configured not to be physically connected to the PC except through a visual connection, or wireless communication connection such as Bluetooth or Near Field Communication (NFC). The mobile device, such as a mobile phone may be configured not to directly physically connect to the computer, but may instead require additional cords or wires in order to make the connection, thereby reducing the chance that the device remains coupled to the PC.

The second factor of authentication may be the user's mobile phone device that users generally take care to maintain control, and which is usually not available to other users. Exemplary embodiments of the disclosure described herein may therefore allow users of PCs and other devices to use very secure pins for logging in that are not guessable and can be very long credential strings. Users do not have to know or remember the pin or login credential to log in. Instead, a user may use a login token. The token may include a pin or password login credential, but never known by the user and/or need be remembered by the user. The token, although it can be unknown to the user, may be stored encrypted at rest.

Exemplary embodiments described herein may include a method and system to recover the encrypted token for authenticating to the user's electronic device, such as a computer (PC), Internet of Things (IoT) device or any electronic device that has inputs and outputs, computing capabilities and digital storage that can support the process of this invention, generally called a computer device.

Exemplary embodiments of systems and methods described herein include or exclude the use of a remote authentication server or use a combination where a device may have access to an authentication server or not. A remote authentication server as used herein is understood to be an electronic device, such as a computer, that is separate from the device to be accessed and the devices of the user, such as the mobile electronic device (mobile phone). The authentication server is generally configured to have or communicate with a storage device, such as memory, configured to store a database or other storage structure. The authentication server is configured to store authentication credentials and/or instructions for determining the authenticity of a user to provide approval signals to a remote device in communication with the authentication server. The authentication server may be in communication with a plurality of different remote devices that can be accessed by one or more user(s) and/or permit access to one or more other electronic device(s). The authentication server is therefore in communication with a network that can be used to authenticate different users to different devices according to the same or similar authentication instructions while maintaining unique credentials for the different combinations of users and/or devices registered with the authentication server prior to the authentication requests. The authentication server may also have a processor to execute the instructions and cause the authentication server to receive authentication credentials from a user and/or one or more electronic devices requesting authentication and sending authentication confirmations or denials to permit access of a user to the one or more electronic devices. The authentication server is separate from the device requesting authentication of the user and/or in any device of the user that is used as an authentication credential of the user in the authentication method.

Exemplary embodiments described herein include systems and methods for access to an offline system comprising a Windows credential provider.

Exemplary embodiments described herein include systems and methods for authentication of an electronic device that is not currently in communication with a network, such as the internet, or communication with a remote authentication server.

An exemplary basic process of authentication may use encryption of a password or pin used by a credential provider (CP) to unlock an electronic device (such as a Window's device, internet of things (IOT) device, personal computer (PC), etc.).

Protection of the user's password or pin may therefore be through encryption, such as Advanced Encryption Standard (AES) symmetric. In this process, there can be two encryptions of the password or pin for user login. As used herein a protected password is one that is encrypted at the system level of the electronic device (PC), while an encrypted password is encrypted at a higher level of encryption external to the system encryption. Therefore, an encrypted, protected password is where a password is encrypted at the system level (i.e. protected password) that is additionally encrypted with a second method of encryption, such as AES, creating an encrypted protected password.

In an exemplary embodiment, the decryption key may be split. In the case of a symmetric key, the encryption key is split after it has been used to encrypt the protected password or pin. One portion of the split key (the extract portion) is encrypted with the public key of the public/key pair with the private key associated with or stored on the user's mobile electronic device.

In an exemplary embodiment, the user's mobile electronic device may include a mobile application that may be configured to securely store the private key on the user's mobile device. The user may have access to the private key and the user's app through an authentication of the user, such as through a password, pin, biometric, etc. of the application and/or of the user's mobile electronic device.

In an exemplary embodiment, the second portion (the remaining portion), of the decryption key is replaced with dummy variables or the section removed for encryption is discarded. A record is kept of which sections were removed or replaced to permit reconstruction of the key once the encrypted segments are decrypted. In one embodiment, the password or pin does not need to be protected before it is encrypted (encrypted password v. encrypted, protected password).

In an exemplary embodiment, the steps of the process may include any combination of the following steps:

First, the offline keys are created. The public/private key pair may be created at a user's mobile electronic device (the authentication or second device). The private key of the public/private key pair may be saved in an authentication application stored on the user's mobile electronic device and/or on the user's mobile electronic device. The public key of the private/public key pair may be stored at the electronic device (the device to be logged into or the first device). As described herein, the public key may be communicated to the electronic device in any manner. In an optional embodiment, the offline keys are created during an online process. Once the offline keys and other needed information are created, then a user can be authenticated during an offline process.

Then, optionally, an encryption key may be created. The example provided herein uses an AES key, but other encryption methods and encryption keys may also or alternatively be used. In an exemplary embodiment, the encryption key (AES key) may be used to encrypt a string, such as a password or pin or other login credential.

In an optional embodiment, a split key may be created. In an exemplary embodiment, the encryption of the string may include encryption of a string with the encryption key. Then, a segment or segments of the AES key may be removed and encrypted with the public key of the user's mobile electronic device (the second device), the public key having been previously transferred to the electronic device (the first device) encrypting the segment. By extracting one or more sections of the AES key, a split key is created. A first portion of the AES split key includes a modified AES key in which the extract portions are removed or replaced with dummy data. A second portion of the AES split key includes the extracted segments of the original AES key. The second portion of the AES split key may optionally be encrypted. In addition, a record of the removed segment locations and an initialization vector (IV) used in regenerating the original AES key may be stored with the split key.

In the process where an asymmetric key pair is used, the private key of the pair may be treated in the manner of the AES key, where a segment of the key is removed and encrypted and the removed segment in the key is replaced with other values. Additionally, any values needed to reconstruct the asymmetric key may also stored.

Exemplary embodiments of the systems and methods described herein may optionally permit online (access to a network and/or remote authentication server) processes to create the keys to be used offline according to exemplary embodiments described herein.

First, an online process may be used to create offline keys and information needed to reconstruct the keys. In this example, an Advanced Encryption Standard (AES) symmetric encryption process is used. Other encryption and decryption can also or alternatively be used, such as, for example asymmetric Elliptic Curve or Rivest-Shamir-Adleman (RSA) cryptography.

Exemplary embodiments of the method of creating an offline key to use for authenticating a user of a device that is not connected to an authentication server but has original access to an authentical server for registration, may include and combination of:

First, connect the first device (the PC or device to ultimately be logged into using the offline processes) to an authentication server through an online connection.

Then, register with the authentication server to create at least an offline login credential for authenticating a user when further connection (and/or any other connection) to the authentication server is not available. The registration process may also optionally include the creation of an online login credential for authenticating a user when the connection to the authentication server is available.

Next, a user key may be created and stored at the authentication server, and the first device according to the embodiments described herein.

In an exemplary embodiment, the user key comprises a public/private key pair.

In an exemplary embodiment, the key pair may be generated on the mobile electronic device and the public key stored at the authentication server along with the key type, such as ECC or RSA. A user's mobile electronic device (the second device) may also be authenticated to the authentication server. Therefore, the user's mobile electronic device (the second device) may generate a public/private key pair in which the private key is stored on the mobile electronic device and the public key is shared and stored at the authentication server. When the first device is connected to the authentication server, the public key may also be communicated to and saved at the first device along with the key type.

Then, a device encryption key (an encryption key) may also be created for offline authentication. For example, a device key may be generated on the PC. One of the device key types may optionally be a symmetric AES key.

Once connected to the authentication server, a login credential that was previously created and protected may be obtained for accessing a device associated with the user, separate from the authentication server.

In an exemplary embodiment, the credential may be protected because it was encrypted by the device being accessed prior to the protected credential being transferred to the authentication server for later retrieval. The login credential may be a knowledge factor, such as a password or pin. The knowledge factor may be received from the user. Preferably, the knowledge factor is obtained by the system, such as from the authentication server in an OpenID Connect (OIDC) token (passClaim).

In an exemplary embodiment, the login credential may therefore be created anywhere in the system, such as through a user input, the authentication system, and/or the first device. The login credential may then be encrypted by the first device and shared and stored with the authentication server as a protected login credential. The login credential may be created at the time of registration and/or may have been previously created for login at the first device.

Once the login credential is obtained by the first device, the login credential is encrypted to protect the login credential. The login credential may be encrypted using the device key, such as the AES key.

In an exemplary embodiment, the device key is split for security into a split key made of a first key of the split key and a second key of the split key, wherein the first key and the second key may be recombined to create the device key. The split key may increase security.

In an exemplary embodiment, when storing the device key at the first device, a split key is generated.

In an exemplary embodiment, to generate a split key, the AES key may be segmented into two or more parts and one or more segments of the AES key removed and/or replaced. In an optional exemplary embodiment, the removed segments of the AES key may be replaced with other characters/numbers, nulled out, or simply removed.

The modified AES key in which segments of the AES key are removed (either through removal or removal and replacement of segments), may be stored as the first key of the split key. The removed segment(s) of the key may be stored separately from the first key and each other or may be concatenated together and stored separately from the first key as the second key of the split key. In an optional embodiment, the removed segments of the AES key may also be encrypted.

In an exemplary embodiment, the removed segments of the AES key may also be encrypted on the PC with the public key of the user's mobile electronic device (the second device) in which the public key has been previously transferred to the PC. Therefore, the device key may comprise a split key having a first key pair as the AES key segments that remained with the replaced segments (or removed segments), and a second key pair as the AES key segments that were removed (and optionally encrypted).

In an exemplary embodiment, a record of the removed segments and their storage locations may be maintained/stored in order to recreate the encryption key along with an initialization vector used in the encryption process. An initialization vector (or IV) are used to ensure that the same value encrypted multiple times, even with the same secret key, will not always end with the same encrypted value. This may be used as an additional security layer. If strings did always have the same result when encrypted, it would be easier for someone to figure out what the starting value was just through brute force trial and error.

In an exemplary embodiment, the sections or segments being removed and later replaced from the key can be defined within the computer code used to execute the process. The split key may be stored at the PC in order to recreate the device key from the split keys. The encryption of the login credential may take place prior to the AES key being split as described herein.

The authentication server may associate and store the encrypted/protected login credential (password/pin) with the user name of the user logging in. The encrypted/protected login credential and the user name may be communicated and stored at the PC.

At the end of this process, any combination of the following elements may be stored locally on the first device, such as the Windows client, with the user name. This data could be stored on a removable storage device, such as a USB stick, and stored separately from the Windows client.
UserName
   Encrypted, protected login credential (or encrypted login credential)
   A first key being the encryption key (AES key) with key segment(s) removed and/or replaced
   A second key being the encrypted encryption key segment(s) removed (encrypted with the public key)
   Initialization Vector for recreating the encryption key, if an AES Key is used
   Location of the segments of the key that were encrypted (the second key)
   Public key
   Public key type (such as ECC or RSA)
   A record of the removed key segments and their storage locations in the other portion of the key.

In an exemplary embodiment, the split key may comprise key segments from the user key in a byte array form made up of numerical bytes in the range of 0 to 990. In this example case, the array may be converted to a string with two leading zero added before bytes with numbers in the range of 0 and 9 and one leading zero for numbers in the range of 10 to 99. The string may then be encrypted using elliptical cryptography (or other encryption method). The string may be communicated to the PC from the authentication server and stored at the PC for offline authentication.

In an exemplary embodiment, the encryption of the removed AES key segment (used to generate the second key of the split key) is performed using standard cryptography processes. For example, elliptical curve cryptography (ECC) may be used for encrypting the key segment on the device being accessed (the first device) and decryption of the key segment on the user's mobile electronic device (the second device), if the user's mobile electronic device is running the Apple iOS. This allows for generating an Elliptical Curve Cryptography (ECC) key pair and decryption using the Apple iOS secure enclave. For Android devices, Rivest-Shamir-Adleman (RSA) cryptography could be used. Other encryption methods may also or alternatively be used.

In an exemplary embodiment using the Elliptic Curve Integrated Encryption Scheme (ECIES), nothing is sent from the users that needs to be decrypted on the computer to which the user is being authenticated. Elliptical cryptography uses symmetric key cryptography for encryption and decryption with a shared secret key created on both the user's mobile device and the computer to which the user is authenticating. This requires creating ECC key pairs on both the computer and the user's mobile device. The public keys are exchanged between the two devices. This is the Elliptic Curve Integrated Encryption Scheme (ECIES) previously known in the art and not to be confused with the split key process disclosed herein.

Another embodiment of this disclosure includes a static ECC key pair created and stored on the user's mobile electronic device and an ECC key pair created on the computer with the private key used to create a shared secret and then discarded. The key pair on the computer can be recreated with each authentication as long as the public key is included with the encrypted key segment with other required data for the decryption such as a vector and tag for Advanced Encryption Standard-Galois counter Mode (AES GCM). The Apple recommended Algorithm is kSecKeyAlgoritnECIESEEncrytionCofactorVariableIVX963SHA256AESGCM.

In another embodiment of the present disclosure, the key pair on the computer for creating a shared secret is computed during online authentication and the key pair is stored at the first device preferably in a Trusted Platform Module (TPM).

In another embodiment of the present disclosure, the offline authentication process according to embodiments described herein is included as an addition to an online authentication process that use the device as a second factor of authentication combined with either or both biometric or a knowledge factor. The online process is used when both the user's mobile electronic device and the computer are connected with an authentication server. An exemplary method to transfer information to and from the device is to use the Open Identity Connect (OIDC) protocols. The public key exchange can occur through an online authentication session and be available for use for creation of offline keys needed for offline authentication. In an exemplary embodiment, the public key from the user's mobile electronic device may be transferred and stored on the computer with each online authentication and the computer public key (ECIES process) may be created during each offline authentication process and transmitted in a QR code along with the encrypted key segment to the user's mobile electronic device. An alternative is to transmit the computer's public key (ECIES process) during an online authentication session(s) and to only compute the computer key pair (ECIES process) when the computer is online and to use a static computer public key for offline sessions. Accordingly, exemplary embodiments may include changing keys that are used only once or changed at each online login, or are static, or a combination thereof.

Although an exemplary embodiment is described in which an authentication server is used in the creation and/or exchange of user keys and/or device keys, the system and method are not so limited. Instead, the keys described herein may be created and shared between the first device and the second device directly. For example, the second device may create the private/public key pair and the public key communicated to the first device. The first device is then configured to the public key of the mobile electronic device of the user (the second device). The application or first device may be configured to receive the public key in any combination of ways. For example, the first device may be configured to scan a presentation of the public key that is provided on the display screen of the mobile electronic device. An application can be written to run on the PC that scans a presentation of the public key presented on the screen of the mobile device, such as in a QR code. The first device may be configured to receive a user input of the public key, such as by the user entering an alpha-number entry on a keyboard. The public key could be presented on the mobile electronic device and then manually imputed into the first device using an application designed to accept an input and store the public key on the PC. The presentation of the public key may be alpha-numeric, quick response (QR) code, bar code, image, etc. As another example, a terminal application could be used or the Windows Shell. Another way is to transfer the public key in an OpenID Connect (OIDC) Identification (ID) token or claim or as part of a user information query when a credential provider uses OIDC to communicate with an authentication server.

Exemplary embodiments of the systems and methods described herein may include multi-factor authentication processes using multiple devices for accessing an offline electronic device that cannot access or is not connected to an authentication server and/or if a second electronic device used for multiple factor authentication cannot access or is not connected to an authentication server.

Once the authentication system is set up and registered and the appropriate keys are created and saved to the respective devices, the user may then login in to the PC (or other computing device) using multi-factor authentication, even if the device being logged into or the user's mobile electronic device does not have access to a network to communicate with the authentication server used to register the user and devices.

Exemplary embodiments may include obtaining an encrypted key from the first device at the mobile electronic device (the second device); using the second device to decrypt the encrypted key, and obtaining the decrypted key at the first electronic device. The decrypted key may then be used to decrypted an encrypted user credential stored at the first electronic device.

In an exemplary embodiment, the encrypted and/or decrypted key may be exchanged between the first device and the second device in any combination of methods. For example, the sending device may display an image representing the code, and the receiving device may have a camera configured to receive the image of the represented code, and may be configured to read or interpret the image to extract the code. The representation of the code may be an alpha-numeric string, a numeric string, a bar code, a QR code, or other visual. As another example, the sending device may display an image of the code, and the receiving device may have a user input configured to receive the code from the user. In this case, the receiving device may have a keypad or other key selection for the user to enter in the displayed code into the receiving device. The sending and receiving device may be connected and permitted to communicate through a wired connection that permits data transfer. The sending and receiving device may be connected and permitted to communicate through a wireless connection such as a near field communication (NFC), or Bluetooth. The sending device may communicate the code to the receiving device through the wired or wireless connection. The sending device may communicate the code to the receiving device through a visual connection, such as an image, visual using a flashlight or flashing of a screen, etc. The sending device may communicate the code to the receiving device through an audio connection, such as playing a sound or series of notes or duration of sounds and receiving the sounds with a microphone to interpret the signals. In an exemplary embodiment, the sending device is the first device and the receiving device is the mobile electronic device when the code is the encrypted key. In an exemplary embodiment, the receiving device is the first device and the sending device is the mobile electronic device when the code is the decrypted key. The system may communicate the encrypted key and the decrypted key between the first device and the second device in the same or different manners.

In an exemplary embodiment, the first device may be configured to receive the decrypted key and decrypt a user credential and log in the user to the first device. In order to decrypt the user credential, the first device may be configured to receive the decrypted key, recreate an encryption key by retrieving the other portion of the split key pair and inserting the decrypted key into the other portion of the split key pair to recreate the encryption key. The first device may then be configured to decrypt the encrypted credential using the encryption key. The first device may be configured to decrypt any other protections of the credential before using the credential to log in the user into the first device.

In an exemplary embodiment, the encrypted key may be communicated from the first device to the second device. For example, the encrypted key may be presented as an image or representation of the encrypted key, such as through a bar code or QR code on a display of the first device. The second device may be configured to receive and interpret the encrypted key by decoding the bar code or QR code. The second device may use the private key of the private/public key pair in order to decrypt the encrypted key.

In an exemplary embodiment, the decrypted key may be communicated back to the first device from the second device. For example, the decrypted key segment may be presented as a numerical code on the mobile device and entered into a first electronic device screen as a key segment used to recover a symmetric encryption key, such as an AES key. The encrypted key segment that is displayed on the first electronic device and read by the user's mobile device is a string of bytes. Before encrypting the string of key segment bytes displayed on the first electronic device, the key segment string is created by concatenating the set of bytes removed from the symmetric key with placeholders inserted to buffer the bytes so that when the key segment string is decrypted and returned to the electronic device, it can be properly parsed. After the decrypted string is entered into the first electronic device, the buffer placeholders are removed to obtain the original bytes to recreate the symmetric key used to decrypt the encrypted, protected token.

In an exemplary embodiment, the encrypted key may be the encrypted segment (second key) of the split key pair described herein.

Exemplary embodiments described herein may work in on-line mode, off-line, or a combination thereof. In the embodiment in which the system can work in a combination of on-line and off-line (herein referred to as the hybrid mode), the system may first determine whether the device has access to a network to communicate with an authentication server. If the device has access to the authentication server, the user may be authenticated using the online process, described herein. If the device does not have access to the authentication server, the user may be authenticated using the offline process, described herein. The system may therefore be configured so that the device in which the user desires to be authenticated may first determine whether access to the authentication server is available, and based on the determination of the authentication server availability (connection), the system is configured to select an authentication mode as either offline without communication with the authentication server or online with communication with the authentication server.

Embodiments described herein may also be used only in offline mode, in which the system does not first check for access to the authentication server, but simply proceeds with authentication in the offline mode described herein.

In an exemplary embodiment comprising a hybrid mode of operation, the CP stored and executed at the first device in which access by a user is being requested is setup to work with an authentication server or without the authentication server. The CP is configured to detect if the device is in communication with an authentication server, and whether the authentication server is available. If the CP determines that connection to the authentication server is available, the CP is configured to display at the device in which access is being authenticated a one-time code. In an exemplary embodiment, the one-time code may be displayed as a QR code, but other configuration of the code may also be displayed. The one-time code may be generated and sent by the authentication server to the device. The user may then image the QR code with an application stored on their mobile electronic device. The mobile electronic device of the user may be in communication with the authentication server, and may receive and communicate the one time code through the QR code to the authentication server along with device identifiers in order to confirm the device sending the one time identifier to the server. The authentication server can then confirm the user is authenticated by identifying the one-time code and confirming the user is registered with the device sending the one time identifier to the server. The authentication server can then send an approval signal to the first device in which access is being attempted to approve access. The device can then be opened to the user and the user logged into the device. Further options of the online authentication process are described below.

If the device determines that access is not available, then the device can proceed in an offline mode. When the CP detects the authentication server is not available (or if an online option is not used in combination with an offline mode), the CP is configured to provide a list of users with encrypted authentication keys. The CP is configured to receive a user selection through a user interface of the device in which access is being requested so that the user may select one of the one or more users listed on the device. Once the user selects a user, the CP may be configured to display either directly or a representation of the encrypted authentication key. In an exemplary embodiment, the text of the encrypted segments of the split key are displayed. Once the user selects a user, the CP may be configured to display a user input for receiving the decrypted segments of the split key from the user.

In an exemplary embodiment, the user interface to the device in which a user is attempting to seek access (a first device) may depend on whether the device has access to the authentication server at the time of the authentication request. When the device is not in communication with the authentication server at the time of the authentication request, the device may display the encrypted segments of the split key described herein as a QR code on a login screen once the user is selected. When the device is not in communication with the authentication server at the time of the authentication request, the device may display an input box to receive an input from the user.

In an exemplary embodiment, a method for authenticating a user may include:
1. The device may optionally detect if the device in which a user is attempting to log into (i.e. PC or first device) is offline.
2. Display a list of available users. Default to the locked user if in locked state.
3. User is selected from a list of available users (similar to the users stored with associated keys under userName in Online Process).
4. Display as a QR the encrypted AES key array segment for the userName.
5. The user scans the QR of the encrypted segment with an authenticated mobile application stored on the user's mobile electronic device and the camera of the user's mobile electronic device. The user's mobile electronic device then uses its private key to decrypt the segment.
6. The authentication application on the user's mobile electronic device displays the unencrypted key segment of the symmetric key associated with the user name.
7. The user enters the unencrypted segment in a CP field on the Windows login screen. The CP on the device then converts the key segment into a byte array.
8. The CP recreates the original AES symmetric key by inserting the decrypted key segment back into the other portion of the split AES key, and also using the previously stored initialization vector. The reconstructed AES key decrypts the encrypted and protected password and other variables needed by the CP to authenticate the user.
9. The CP may optionally create a new AES symmetric key and initialization vector, encrypt the protected password, encrypt a new AES key segment, and store the new values. As long as the user maintains and has their mobile device with the authentication application with a private key corresponding to the public key stored by the CP for that user, they can login to the PC.
10. The CP then decrypts (ToUnprotectedString) the protected password, confirms the password by submitting it to the system for logging in and if confirmed logs in the user.

Other methods and systems to transmit the encrypted key segment to the user for decryption by the private key on their mobile device can be used. For example, the mobile electronic device and the device to which the user is attempting access may be in wireless communication, such as connected through Bluetooth or near field connection (NFC), or other connection, such as an audio connection. The decrypted key segment may therefore be manually entered by a user, or can be provided to the PC's CP by other interfaces, including without limitation, Bluetooth connection, near field connection, visual connection, or audio connection. In one embodiment, a visual connection may use morse code using the flashlight on a mobile device read by a photo sensor on an electronic device.

Once this process is completed timeouts and fail counts may optionally also be used to reduce the potential for a brute force attack. For timeouts, the process could return to the initial login screen. For fail counts, a maximum limit could be set with progressively longer wait times between attempts. The encrypted key segment should be long enough to limit the potential for a brute force attack. Also, the process may optionally create a new encryption key and encrypted key segment every time the user logs in so that the encrypted key segment has only a one time use and is being rotated frequently. During offline login, a new encryption key and key segment can be created, following a similar process to key creation that takes place during an online login. For offline key creation during offline login, the existing stored public key of the user can be used.

In an exemplary embodiment, the invention is designed in one case for the public key of a public/private key pair to be transmitted from the user's mobile device to the user's computer or user's server through the authentication server. In an example case, the public key is transferred using OIDC methods.

In another exemplary embodiment, the public key is transferred to the PC using an application on the PC that can transfer the public key from the user's mobile device through Bluetooth, NFC, QR read, manual entry typed in an input of the PC. An application on the user's mobile device may be use to display a QR code or text of the public key or to transfer by Bluetooth or NFC or other means the public key to the user's PC or Server or other device such an internet of things device that the user is attempting to log into. In one embodiment, the entire login process, including registering the public key, may be entirely offline.

In this invention, the process has to keep the public key on the first electronic device in sync with the private key on the user's mobile device. In one embodiment, the electronic device is connected over the internet to an authentication server during every authentication process and transmits the current public key and key type to the authentication server for storage. The next time the mobile device is used to log into the first electronic device, the current public key and key type are sent to the first electronic device for storage. The first electronic device updates the encryption of the encrypted token, the encryption key, key type, any initialization vectors, and the encrypted key segment during each of these login events. Encryption of the token is performed with a new symmetric key and a new symmetric key segment is encrypted using the current public key. In the case of an electronic device with computing capability that is never connected to the internet or has no online means to authenticate to a server for the transformation of the public key, the user device public key update will be done manually when the device is authenticated or during a reset. In one embodiment the mobile device is a NFC or Bluetooth dongle with biometrics capable of creating or storing a public/private key pair that allows the process described herein for logging into a machine without an internet connection.

In another embodiment, encryption and storage of the protected token or encrypted token that is used to authenticate to the electronic device, and that is encrypted with a key and the key segment that is generated and encrypted using the user's public key for transmission for decryption in the user's mobile device using the users private key is performed on every authentication. This results in the encrypted key segment that is being transmitted for decryption and then returned, unencrypted for re-creating the key to decrypt the encrypted token being changed on every authentication. The key segment is different on every offline authentication preventing the reuse or sharing of the key segment.

### Windows Credential Provider Online Process Steps

Exemplary embodiments described herein provide for access to a Microsoft machine. Exemplary embodiments of the systems and methods described herein are configured to set the registry keys in a Window machine as described herein so that the Windows authentication logon can be set to use a secure method that provides a passwordless multi-factor authentication process that secures the remote login. In an optional configuration, the logon to the machine can be forced to display a QR code representing a one-time passcode that can be read by an application on the user's possessed device and communicated to an authentication server to verify the authentication. Exemplary embodiments described herein may be configured for direct access to a Microsoft machine or for remote access to another device.

In an exemplary embodiment, the system may comprise a first application resident on a user's personal electronic device. The application may be stored as non-transitory machine readable instructions within memory of the user's personal electronic device. The application may be configured to perform functions described herein when executed by a processor of the user's personal electronic device. Exemplary functions of the application may include receiving a code and sending the code to an authentication server. In an optional configuration, the receipt of the code may be through a user interface displayed to the user and a code entered into the user input. In an optional configuration, the receipt of the code may be through a user interface in which the user takes a picture of the code and the application is configured to extract the code from the image. In an optional configuration, the code may be contained within a QR code, bar code, or other visual code that may be extracted from the picture of the code.

In an optional embodiment, an application resident on the user's personal electronic device may be configured with its own authentication requirements before the user may access the application on the user's device. For example, the application may require a user's password, biometric authentication (such as face or fingerprint), pin codes, or other access requirements. Once the application is accessed, the application may be executed and may be configured to use the user's electronic device to receive an image and communicate with an authentication server.

Once the user executes the application on the user's electronic device, the application may be configured to connect to an authentication device. In an exemplary embodiment, the user's electronic device, application, and/or credentials may be registered with the authentication device. The application may be used to create a secure connection between the authentication server and the application of the user's electronic device.

In an exemplary embodiment, the system may comprise a second application resident on the device to be accessed by a user. The application may be stored as non-transitory machine readable instructions within memory of the device to be accessed by a user. The application may be configured to perform functions described herein when executed by a processor of the device to be accessed by the user. In an exemplary embodiment, the application may be configured to modify registry key(s) of the device to be accessed by the user to limit the registration credential to a single credential provider that is installed to handle the specific authentication process. In an exemplary embodiment, the exclusive use of the credential provider may be configured to send the one time code to the device of the user by modifying the registry keys of the operating system. In an exemplary embodiment, the first device is an electronic device running Microsoft Windows operating system. In an exemplary embodiment, the Microsoft Windows operating system comprises registry keys to set the authentication system used to authenticate a user to the first device. An optional configuration of the application may be to display a code as a log in screen on the device to be accessed by a user. The display of the log in screen may also be communicated in whole or in part to another device if the user is attempting remote access to the device to be accessed by a user from another device. As described herein, the code may be an alpha-numeric code or may be contained within an image, such as a QR code or bar code or other visual depiction of a code. In an optional configuration of the system, the device to be accessed by a user is a Microsoft machine.

In an optional embodiment, the system may comprise a third application resident on a remote device that may be used to access a device to be accessed by a user. The application may be stored as non-transitory machine readable instructions within memory of the remote device. The application may be configured to perform functions described herein when executed by a processor of the remote device. In an exemplary embodiment, the application may be configured to communicate with the device to be accessed by a user. The application may also or alternatively be configured to retrieve a login interface from the device to be access by a user and display the retrieved login interface to a user at the display of the remote device.

In an exemplary embodiment, the system may comprise a fourth application resident on an authentication device that may be used to authenticate the user and/or second or third device for access to the device to be accessed by a user, either directly or indirectly from the remote device. In an exemplary embodiment, the application is configured to permit communication between the authentication device and the device to be accessed by a user and also between the authentication device and the user's personal electronic device. The application may be configured to generate a code and send the code to the device to be accessed by a user. The application may also be configured to receive the code from a user through the application on the user's personal electronic device. The application may be configured to authenticate the code and confirm an access permission for the device to be accessed by a user from the code. The application may be configured to communicate the access permission to the device to be accessed by the user and thereafter permit the device to be accessed by a user to log in the user to the device to be accessed by the user.

In an exemplary embodiment, the authentication device may be configured to confirm the one time code. To confirm the one time code, the authentication device may compare the received code with a prior code stored at the authentication server. In an optional configuration, the one time code may be generated by the authentication server and communicated to the first device. The one time code may be stored at the authentication server for comparison upon receipt of a code from the second device. In an optional configuration, the one time code may be generated by the first device and communicated to the authentication server. The authentication server may be configured to store the code received from the first device for comparison upon receipt of a code from the second device. In an exemplary embodiment, to confirm a comparison between the stored code at the authentication device and the received code from the user's personal electronic device, the comparison must match. In an exemplary embodiment, to confirm a comparison between the stored code at the authentication device and the received code from the user's personal electronic device, the comparison must match within a threshold.

Exemplary embodiments have been described herein in terms of one or more applications resident on different system components and electronic devices. Exemplary embodiments are not so limited and features of one application may be performed by other applications. For example, the communication between devices may be managed by one or more of the different applications as would be understood by a person of skill in the art.

The device to be accessed by a user may be securely connected to the authentication device. In an exemplary embodiment, an OpenID Connect (OIDC) protocol may be used for the exchange of information between the authentication server and the credential provider on the device to be accessed by a user. Other protocols such as SAML could be used.

Examples are provided herein with references to the drawings provided herewith. The examples provided herein are exemplary only and not intending to be limiting. Features may be removed, added, duplicated, separated, or recombined and remain within the scope of the instant disclosure.

Exemplary embodiments described herein include systems and methods for providing multi-factor authentication of a device that is offline and not in communication with an authentication server. Exemplary embodiments may include a registration process and a login process. The registration process may be used to configured a user's mobile electronic device and the user's electronic device in which the user intends to log in and take advantage of the authentication process described herein. The login process may be used to log in a user to an electronic device that is not in communication with an authentication server at the time of logging in the user to the electronic device. The login process may permit multifactor authentication by using the user's registered personal mobile electronic device.

In an exemplary embodiment, the systems and methods may permit an exchange of identifiers between the mobile electronic device and the electronic device in which the user intends to login in order to authenticate the user and permit access to the electronic device if the identifiers match to a desired degree. In an exemplary embodiment, other options are optional, such as in rotating or changing identifiers to limit the user of an identifier for a given amount of time or make the identifier a single user identifier. The identifiers may alternatively be static over a period of time. Exemplary embodiments also include different options for sharing the identifiers between the mobile electronic device and the electronic device to be logged in. The examples provided herein may provide one identifier being shared from the mobile electronic device to the electronic device to be logged in; however, it is understood that the opposite exchange is also within the scope of the instant disclosure. The interfaces for exchange of identifiers are also options and can be interchanged as described herein. For example, any use of a QR code with a camera, a user input entering in a code from another device, NFC, Bluetooth, or other communication exchange can be substituted for each and remain within the scope of the instant disclosure.

In an exemplary embodiment, the mobile device can detect if the electronic device being accessed is offline based on the data transferred to the mobile device during a login attempt, such as through a QR Information contained in the data may specify that the data is to be used for an offline login attempt. The mobile device automatically processes the transferred data and determines if it is to be used for online of offline use and proceeds accordingly. The mobile device does not have to have an online connection and can be used in an offline state during an offline login. The mobile device may perform a connectivity test to determine if the mobile device is online or offline. The display of the mobile device may indicate to the user whether it is online of offline.

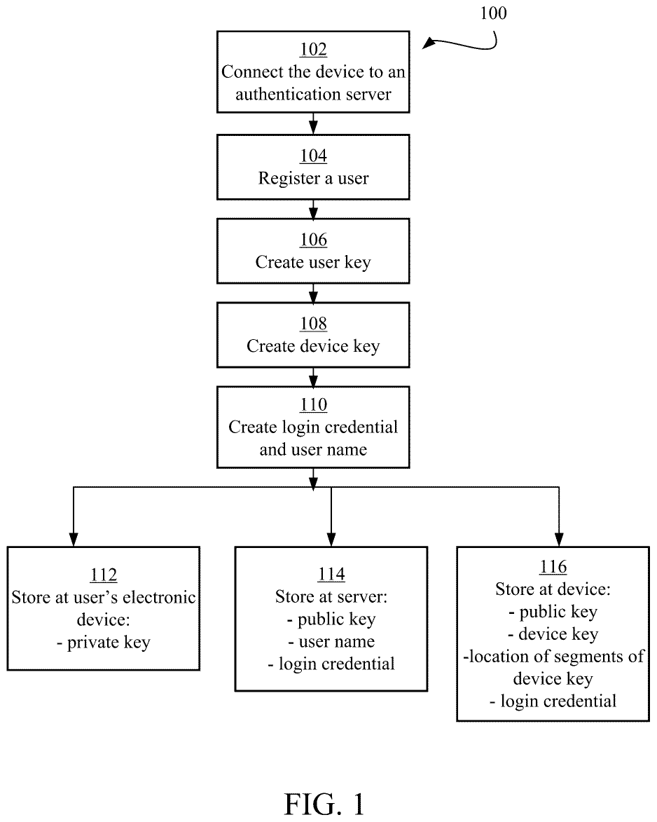

FIG. 1 illustrates an exemplary method 100 of providing multi-factor authentication of a device that is offline and not in communication with an authentication server. FIG. 1 illustrates an exemplary method with respect to an exemplary registration process. The registration process may be used to configured a user's mobile electronic device and the user's electronic device in which the user intends to log in and take advantage of the authentication process described herein.

At step 102, the process starts by connecting the electronic device (to which the user wishes to log in—the first device) to an authentication server through an online connection.

At step 104, the user may be registered with the authentication server. The registration may include creating user information including login credentials. In an exemplary embodiment, the authentication server may create an online login and offline login credentials for authenticating a user with or without further connection to the authentication server. Optional configurations may include creating only an offline login and without the online login. Optional configurations may receive login credentials from a user. The optional configurations may include obtaining login credentials (include such as creating online and/or offline credentials). The authentication server may obtain login credentials by different methods.

At step 106, a public/private key pair may be created on the user's mobile electronic device and the public key stored at the authentication server, the user's mobile electronic device (the second device), and the Window's device (the first device) with MFA according to the embodiments described herein. In an exemplary embodiment, the authentication server stores the user public key. In an exemplary embodiment, the user key comprises a public/private key pair. The private key used to decrypt the encrypted key segment is created and stored on the mobile electronic device, and the public key is communicated and saved on the authentication server. The public key may also or alternatively be communicated to and saved at the electronic device to be logged into.

At step 108, on the first electronic device, a device key may also be created for offline authentication. The device key may be a symmetric AES key. The AES key may be further encrypted to create the device key. In an exemplary embodiment, the device key comprises a split key made of a first key of the split key and a second key of the split key, wherein the first key and the second key may be recombined to create the device key. The split key may increase security. In an exemplary embodiment, to generate a split key, the AES key may be segmented and segments of the AES key removed. The removed segments of the AES key may be replaced with other characters/numbers, or simply removed. The modified AES key in which segments of the AES key are removed (either through removal or removal and replacement of segments), may be stored as the first key of the split key. The removed segments of the key may be stored separately as the second key of the split key. The removed segments of the AES key may also be encrypted. Therefore, the device key may comprise a split key having a first key pair as the AES key segments that remained with the replaced segments (or removed segments), and a second key pair as the AES key segments that were removed (and optionally encrypted). A record of the removed segments and their storage locations may be maintained in order to recreate the AES key. The sections or segments being removed and later replaced can be defined within the computer code used to execute the process. The device key, including for example, the first key of the split key and the second key of the split key, may be created and stored on the PC. The locations of the split key may be stored at the PC in order to recreate the device key from the split keys.

At step 110, once connected to the authentication server, a login credential that was previously created and protected is obtained for accessing a device associated with the user, separate from the authentication server. The credential is considered protected because it was encrypted by the device being accessed prior to being transferred to an authentication server for later retrieval. The login credential may be a knowledge factor, such as a password or pin. The knowledge factor may be received from the user. Preferably, the knowledge factor is obtained by the system, such as from the authentication server in an OIDC token (passClaim).

In an exemplary embodiment, the login credential (password) is created on the PC and protected there (system encryption). It is then sent to the authentication server in that protected state for later retrieval. When retrieved it is ‘Un-protected’ for logging in. During an online login, that protected credential is retrieved by the PC and that kicks off creating what's needed for the offline process. (an encrypted-protected credential. Essentially a doubly encrypted password). The offline setup process includes encrypting that protected password (using AES) and the split key process needed to reconstruct the AES and decrypt the encrypted-protected password. The password will then be in a protected state but since it is on the system, the system can unprotect it. Protection/unprotection is a system level encryption process separate from our AES encryption.

At step 112, the public key is saved at the user's mobile electronic device (the second device). The user's electronic device (the second device) may be coupled to the electronic device (the first device) and send the public key to the electronic device. The user's electronic device (the second device) may communicate directly with the authentication server to store the public key created on the second device. For example, an application running the user's electronic device (the second device) may be configured to communicate with the authentication server when the electronic device has access to a communication network (such as WiFi or cellular network). Other ways of sending the data from the mobile electronic device may also be used, such as downloading the information, sending through email, or other communication methods.

At step 114, the public key, user name, and login credentials, or a combination thereof may be saved at the authentication server. The data may be stored in an encrypted manner, and/or may be segmented for further protection.

At step 116, the public key, device, key, location of segments of the device key, and/or login credentials, or any combination thereof may be saved at the electronic device (the first device). The data may be stored in any encrypted manner, and/or may be segmented for further protection. In an exemplary embodiment, the electronic device may have stored therein, a user's username, Encrypted/Protected Windows Password (encrypted with the AES key, AES key with key segment removed and replaced, encrypted AES key segment (encrypted with the user's public Key), initialization Vector for AES Key, location of the segments of the key that were encrypted, and/or public key.

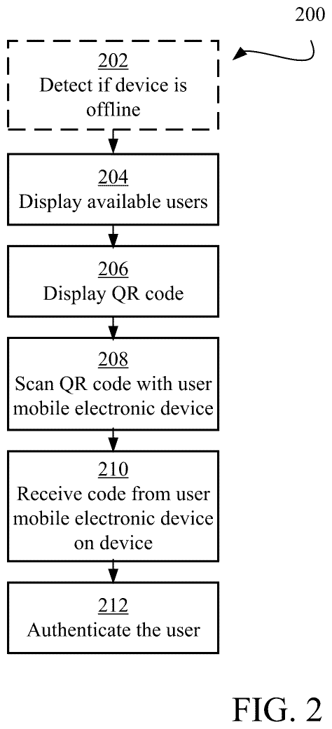

FIG. 2 illustrates an exemplary method 200 of providing multi-factor authentication of a device that is offline and not in communication with an authentication server. FIG. 2 illustrates an exemplary method with respect to a login process after registration. The login process may be used to log in a user to an electronic device that is not in communication with an authentication server at the time of logging in the user to the electronic device. The login process may permit multifactor authentication by using the user's registered personal mobile electronic device.

At step 202, the electronic device in which a user is trying to authenticate themselves and obtain access (a first device) may optionally detect if the device is offline or whether the device has access to an authentication server.

At step 204, the system may display a list of available users. The display of users is optional. If the device is locked after access by a specific previous user, then the user to be logged in may be assumed or selected to be the previously logged in user. If the device is available or registered to a single user, then the user to be logged in may be assumed or selected to be the registered user. If multiple users are capable of logging into the device, then a user may enter an identity of a user, such as a user name, that is not selected from a pre-registered list, but simply entered by a user. Other user selections are within the scope of the instant disclosure. For example, a list may be displayed, either on the electronic device (the first device) and/or on the mobile electronic device of the user (the second device). Other selections may also be listed or offers, such as in user/device combinations. If the user is provided a list on the user's mobile electronic device, the list may only provide accounts available to that mobile electronic device, instead of providing a list of all users. In an exemplary embodiment, the process includes displaying a list of available users. In an exemplary embodiment, the user is defaulted to a locked user, without displaying a list of users, if the device is in a locked state relative to a specific user. If a list is displayed to a user, then a user is selected from a list of available users (users may be stored with associated keys under userName in Online Process above). If the user is available for offline access, a QR containing the user's encrypted key segment is displayed.

At step 206, once a user is selected (such as from a list, by the user, or automatically by the system), an identification may optionally be displayed on a display of the electronic device (the first device). The identification may be made through a display of the identification number. The identification may be an alpha-numeric number that is displayed. The identification may be represented, such as in a QR code, bar code, or other visual representation. In an exemplary embodiment, a QR code is displayed to the user on the electronic device (the first device). The QR code may comprise the identification, such as the encrypted AES key array segment for the username as described herein. The QR may contain data needed for ECIES or RSA or other decryption methods that use a private key stored on the device scanning the QR, in addition to items related to the encrypted key segment such as an initialization vector, nonce, or public key depending on the standard cryptography method being used.

At step 208, the identification number may be entered or received by the mobile electronic device of the user (the second device). The identification number may be received at the mobile electronic device using the camera of the mobile electronic device and recognizing the identification number displayed on the electronic device. The identification number may be received from the electronic device through NFC, Bluetooth, or other communication method. In an exemplary embodiment, the user scans the QR of the encrypted segment with an authentication mobile application stored on the user's mobile electronic device and the camera of the user's mobile electronic device. The user's mobile electronic device then uses its private key to decrypt the segment.

At step 210, depending on the identification number received at the mobile electronic device, the mobile electronic device provides a second identification number back to the electronic device (the first device). The mobile electronic device may provide a second identification number corresponding to the electronic device as determined by the identification number. The second electronic device may communicate the second identification number by displaying an identification number to the user so the user can enter the second identification number in a user interface of the first electronic device. The second electronic device may communicate the second identification to the first electronic device through NFC, Bluetooth or other communication method. In an exemplary embodiment, the authentication application on the user's mobile electronic device displays the unencrypted key segment of the symmetric key associated with the user name. The user enters the unencrypted segment in a user input field on the Windows login screen. The program on the device then converts the key segment into a byte array.

At step 212, the first electronic device confirms the second identification number according to embodiments described herein and if correct, the system permits access of the first electronic device to the user. In an exemplary embodiment, the program on the electronic device (the first device) recreates the original AES symmetric key and decrypts the encrypted/protected password and other variables needed by the application to authenticate the user.

In an exemplary embodiment, the method may also optionally include updating or changing the identification numbers for the next log in attempt. In an exemplary embodiment, the program on the electronic device may optionally create a new AES symmetric key and initialization vector, encrypt the protected password, encrypt an AES key segment, and store the new values. As long as the user maintains and has their mobile device with the authentication application with a private key corresponding to the public key used to encrypt the key segment, they can login to the PC using embodiments of the method and system described herein. The program on the electronic device may then decrypt the protected authentication credential, confirm the authentication credential, and if confirmed, log in the user.

In an exemplary embodiment, the systems and methods described herein may include different identification numbers. The first and/or second identification numbers may be different combinations of the user key, device key, public key of a public/private key pair, split key, login credential, or other combination of identifiers as described herein.

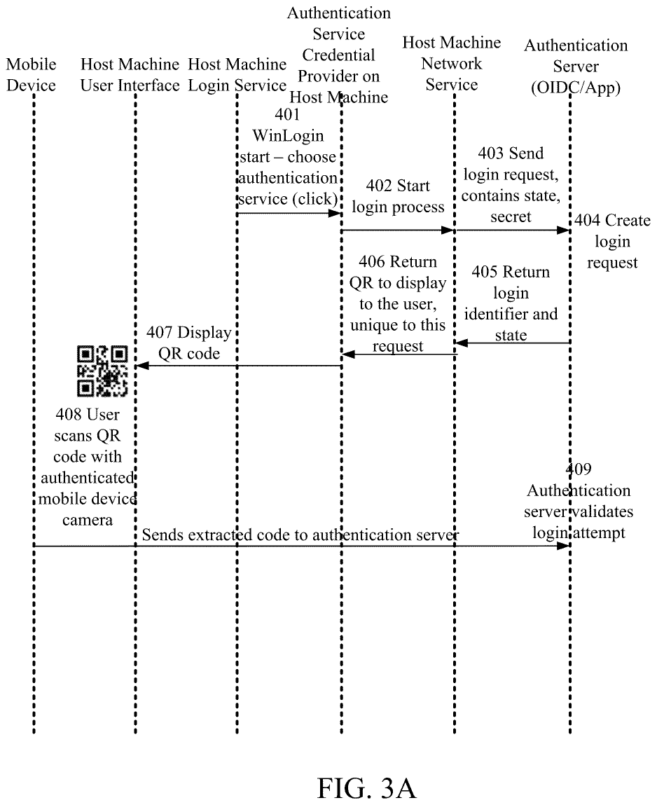

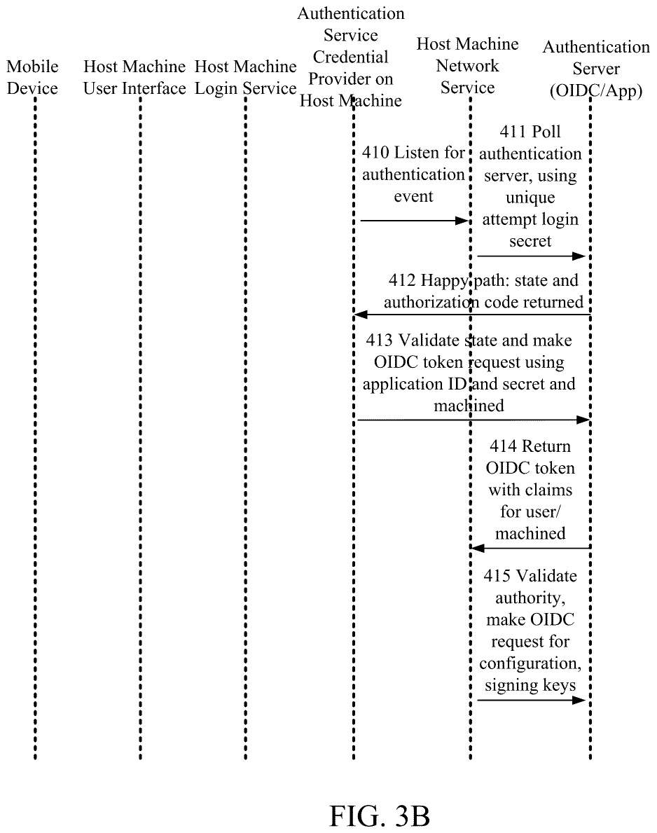

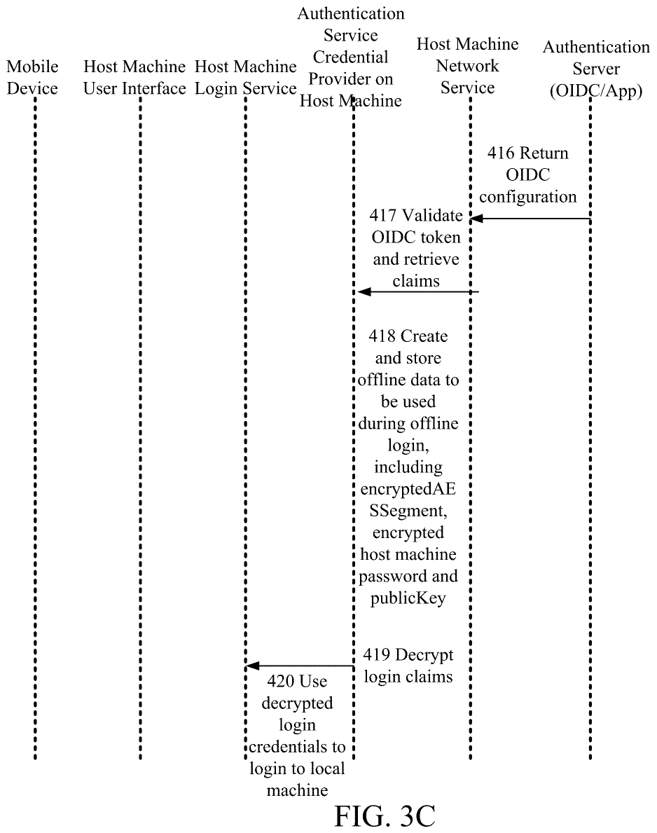

FIGS. 3A-3C illustrates an exemplary successful login to a machine that results in the creation and storage of data used for an offline login.

FIGS. 3A-3C shows an embodiment where a successful login to a host machine using a passwordless credential provider results in the creation and storage of data that can be used for a login when the host machine is offline. In this embodiment a user starts an authentication to a host machine 401 via a user interface. The request is passed to the credential provider on the host machine 402 which then sends the request for a login 403 to an authentication server 404. The authentication server returns a login identifier and state 405 to the credential provider on the host machine. The credential provider sends a representation of the login request as a QR code 406 to the user interface of the host machine 407. The user scans the QR code with an authenticator installed on an authenticated mobile device 408. The authentication server validates the login attempt 409. The credential provider listens for an authentication event 410 and polls the authentication server for a response to the login request 411. If the authentication attempt is successful a state and authorization code are returned to the credential provider 412. The credential provider validates the state value and makes a request to the authentication server for an OpenID Connect (OIDC) token 413. The authentication server returns the OIDC token 414 which contains claims about the user including an encrypted host machine password and user identifier. The integrity of the OIDC token is validated with a request to the authentication server 415 where the server returns the needed OIDC configuration 416 needed to validate the token. The credential provider validates the token and extracts the claims from the token 417. A process is initiated where the credential provider creates and stores data to be used in an offline login 418, including an encrypted AES key segment, doubly encrypted host machine password, and a public key previously associated with the user logging in to the machine. The singly encrypted password and user identifier from the OIDC token are decrypted 419 and user to log into the host machine 420.

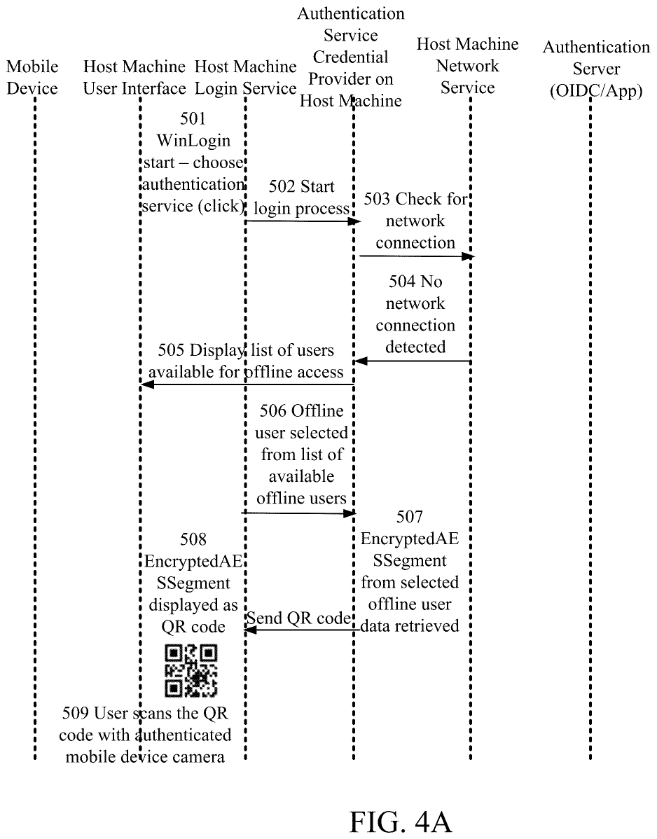

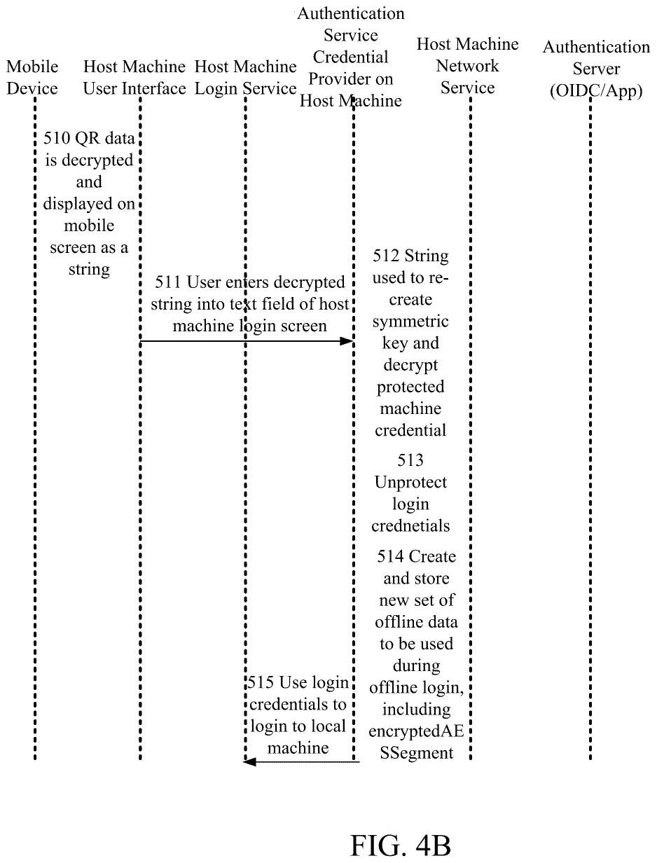

FIGS. 4A-4B illustrates an embodiment of the current invention where a user logs into a host machine while the machine is offline where the user has previously logged in while online to create data used in an offline login.

FIGS. 4A-4B shows an embodiment of the current invention where a user logs into a host machine while the machine is offline where the user has previously logged in while online to create data used in an offline login. The user initiates the login process 501 on the host machine via a credential provider 502. The credential provider detects the network connection state 503. When no network connection is available 504 the user interface presents a list of users available for an offline access 505. The user selects an offline user from the list of users 506. Once a user is selected, an encrypted key segment is retrieved from storage 507 and presented to the user 508 as a QR code. The user authenticates a previously created account on the mobile authenticator and scans the QR code 509. The encrypted key segment is decrypted by the private key on the mobile authenticator and displayed as a string on the mobile device screen 510. The user enters the string into a text field on the host machine login screen 511. The string is used to recreate a symmetric key that can be used to decrypt the first encryption layer of the doubly encrypted host machine credentials 512. The second layer of the host machine credentials are then decrypted by the machine 513. A new set of offline data is created to be used during the next offline login attempt 514. The decrypted login credentials are used to log into the host machine 515.

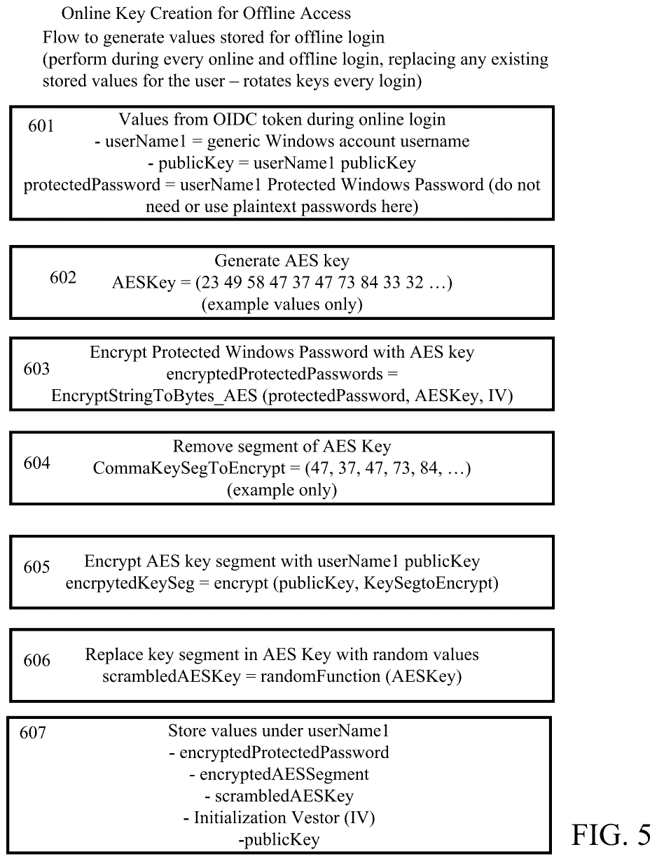

FIG. 5 shows an embodiment of the current invention where an installed credential provider creates and stores values for use in an offline login on a host machine. These steps may take place during every online and offline login attempt, where existing values may be replaced with new values, allowing the values to rotate with every login. During an online login, contents from a received OpenID Connect (OIDC) token are parsed 601 by the credential provider. In one embodiment these are the userName of an account on the host machine, a publicKey generated by a user's software authenticator, and an encrypted password of the host machine. The credential provider generates a symmetric cryptographic key, such as an AES key 602. The encrypted password from the OIDC token is encrypted again with the symmetric key 603, creating a doubly encrypted password. A segment of the symmetric key is removed 604 and the segment is encrypted with the public key from the user's software authenticator 605. Random values are generated and used to replace the portion of the symmetric key that was removed 606, creating a key that cannot be used to correctly decrypt the doubly encrypted password, and requiring the original segment to be used to successfully reconstruct the original symmetric key. Several values are stored on the host machine to be used during offline login attempts 607 including the doubly encrypted password (encryptedProtectedPassword), the encrypted key segment (encryptedAESSegment), the symmetric key with a portion replaced with random values (scrambledAESKey), and initialization vector (IV), and the public key from the software authenticator.

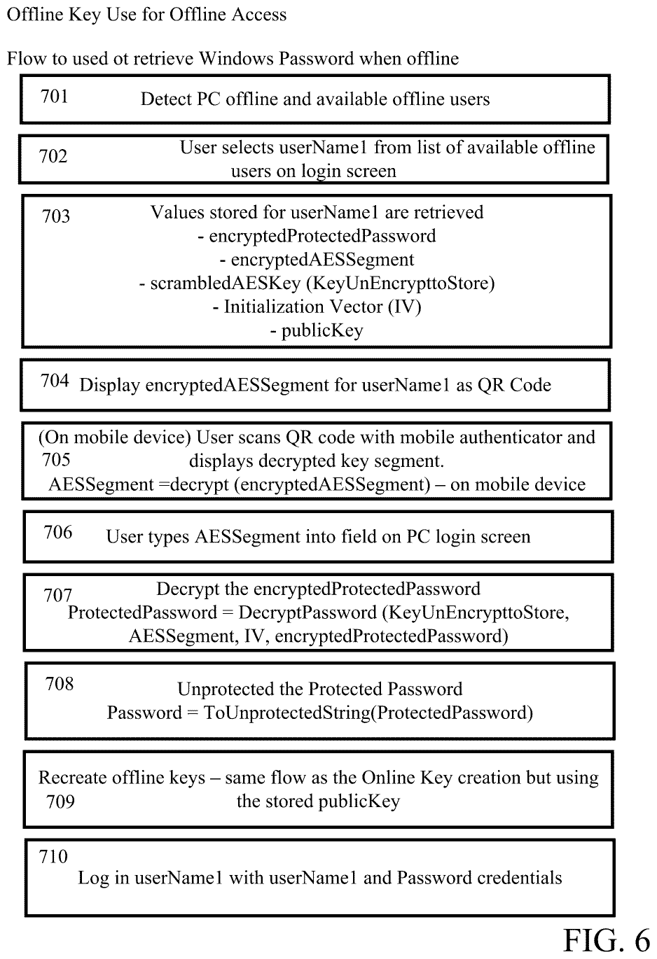

FIG. 6. shows an embodiment of the current invention where the credentials needed to log into a host machine are retrieved and used by an installed credential provider for offline login while the host machine is offline. The credential provider detects that the host machine is offline and there are available offline users 701. A user selects a username from a list of available offline user on the login screen 702. Values previously stored 607 are retrieved 703. In one embodiments, the encrypted key segment is displayed as a QR code on the screen of the host machine 704. The user scans the QR code with the authenticated mobile authenticator 705 and the mobile authenticator uses the private key to decrypt the key segment and display the decrypted value on the screen of the mobile authenticator. The user types the decrypted key segment into a field on the host machine 706. The decrypted key segment is inserted back into the original symmetric key, replacing the random placeholder values that had been inserted in its place, and the restored symmetric key is used to decrypt the doubly encrypted password, resulting in a singly encrypted password 707. The encrypted password is unprotected locally 708. A new set of offline keys is created and stored following the steps in FIGS. 3A-3C 709, but using the existing, stored public key instead of obtaining it from an OIDC token. The credential provider uses the username and password to log the user into the host machine 710.

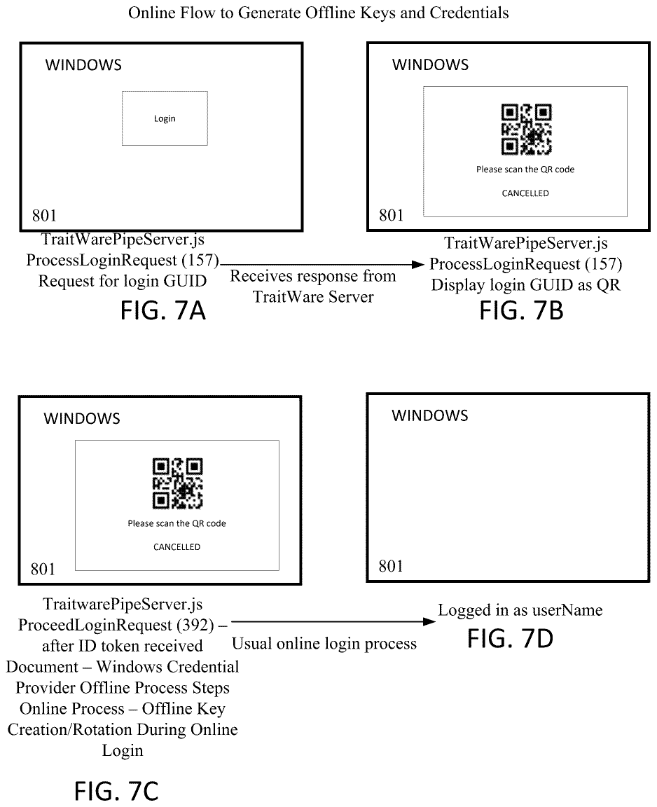

FIGS. 7A-7D shows an embodiment where an installed credential provider can be used during an online login to create data to be used during an offline login. The credential provider displays a login screen to the user on the host machine 801 and the user clicks the arrow to initiate an online login. A QR code is presented to the user and the user scans the QR code with their authenticated software authenticator 802. The credential provider obtains an OpenID Connect token with login data, such as an encrypted password and that data is used to create and store data for offline login use 803. After creation and storage of the offline data, the user is logged into the host machine 804.

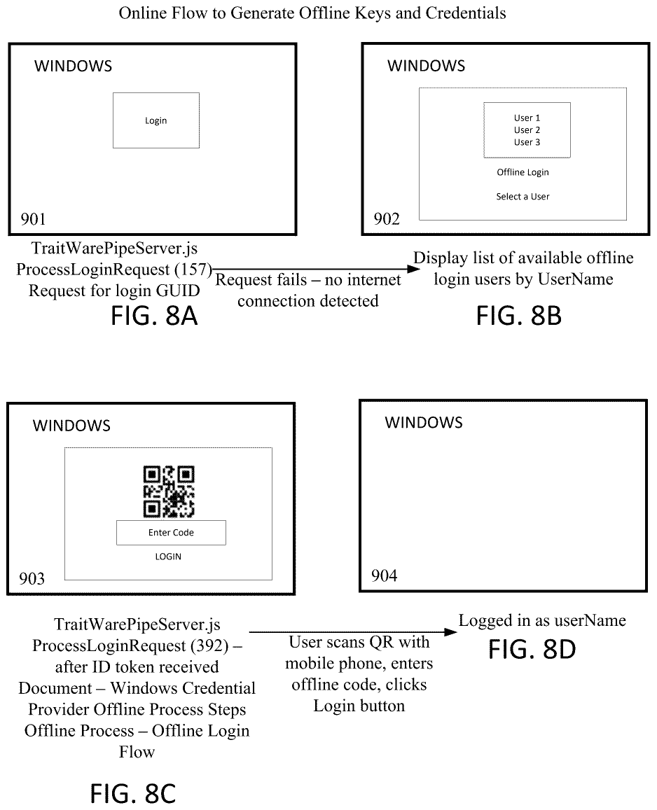

FIGS. 8A-8D shows an embodiment of the current invention where data for offline login is used to allow a user to log into a host machine when the host machine is offline. The host machine checks if it has online access 901. If it does not have online access, a list of users is displayed for offline login 902. A user is selected from the list of users 902. If available, offline data previously stored for that user is accessed and a QR code containing an encrypted key segment is presented 903. The user uses their authenticated software authenticator to scan the QR code presented 903. The software authenticator decrypts the data in the QR code and the user enters the decrypted code into the offline code field 903. The user clicks a login button to submit the offline code 903. The credential provider uses the entered code to reconstruct the key needed to decrypt the host machine login credentials 903. The credential provider creates new offline data and stores it for the next use. The credential provider uses the login credentials to log the user into the host machine 904.

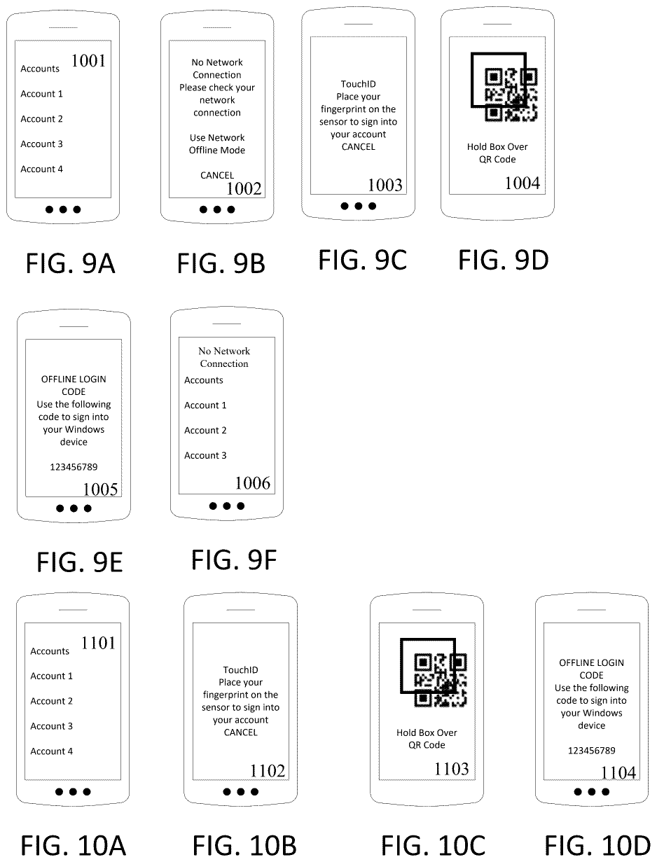

FIGS. 9A-9F shows an embodiment of the current invention where an account on a user's mobile device 1001 (a second device) is attempted to be accessed. The device determines it is offline 1002 and presents the user an option to authenticate offline to the second electronic device. The user is presented with an authentication method 1003 such as a biometric. Upon authentication the user is given access to a camera 1004 to scan a QR code with encrypted information needed for an offline login to the first device. The second device attempts to decrypt the contents of the QR and if successful displays a message with a numerical code 1005. The user can type that code into the first electronic device to authenticate to the first electronic device. The second device can display the connection status to the user 1006.

FIGS. 10A-10D shows an embodiment of the current invention where a user's mobile device is online 1101. The user selects an account and is presented with an authentication method 1102 such as a biometric. The user is authenticated while online and is given access to a camera 1103 to scan a QR code with encrypted information needed for an offline login to the first device. The second device attempts to decrypt the contents of the QR and if successful displays a message with a numerical code 1104. The user can type that code into the first electronic device to authenticate to the first electronic device.

Exemplary embodiments described herein include systems for implementing the process of remotely accessing a remote device (a first device). Exemplary embodiments may include machine readable instructions stored on one or more memory that when executed by one or more processors are configured to perform the processes described herein. The instructions may be stored between a mobile electronic device (a second device) of a user, an authentication device (server), a device to be accessed by a user (the first device, a remote device, a third device), another server, or a combination thereof.

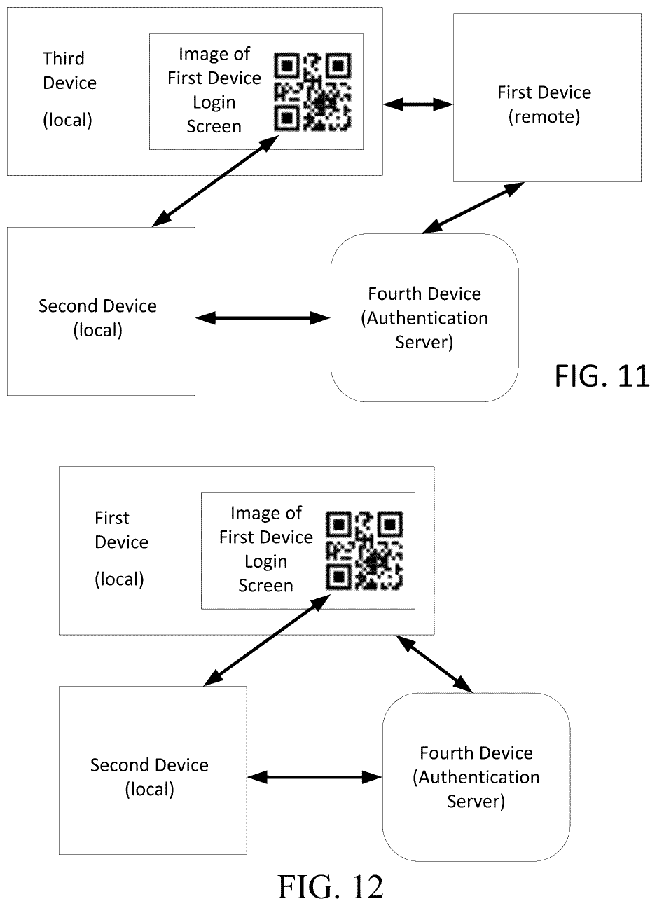

FIG. 11 illustrates an exemplary embodiment in which a user desires to access a first device remotely from a third device. The system uses an authentication server (fourth device) as described herein to confirm that access is permitted through information received from a second device, where each of the first, second, third, and fourth devices are separate electronic devices.

Exemplary embodiments of the process of remotely accessing a first device may include: connecting the first device to an authentication server; generating a one time code; transferring the one time code to a second device; connecting the second device to the authentication server; sending the one time code from the second device to the authentication server; confirming the one time code with the authentication server; modifying the first device to exclusively use only one credential provider to authenticate a user; communicating approval for authentication of the user from the authentication server to the first device when the one time code is confirmed with the authentication server; and signing the user into the first device after the approval for authentication of the user is communicated to the first device.

The second device may be an electronic device of the user. In an exemplary embodiment, the second device may be a smart phone, tablet, laptop, or other electronic device of the user. In an exemplary embodiment, the second device may have stored on memory therein instructions that when executed by the processor of the second device are configured to receive images. In an exemplary embodiment, the second device comprises a camera and the images are from the camera. In an exemplary embodiment, the one time code is contained in an image and the image, with the one time code, is configured to be transferred to the second device by receiving an image of the second device through the camera of the second device communicated to the application of the second device. In an exemplary embodiment, the application is configured to securely communicate with the authentication server. The application may be configured to send the one time code through the secure connection. Other configurations of receiving the one time code at the second device are also contemplated herein. For example, a wired or wireless connection may be created between the second device and the third device. For example, the second device may be coupled to the third device through Bluetooth, near field communication (NFC), wifi, etc. The one time code may be transmitted to the second device from the third device through the wired or wireless communication between the devices. The one time code may also be typed by the user in a user interface of the second device. The one time code may also be received in other configurations, such as other visuals, gestures, user inputs, etc.

In an exemplary embodiment, the second device may have stored thereon an application. The application may be configured to be executed by the processor of the second device. The application may be configured with optional features. For example, the application may be configured to permit access to a user after a credential is verified. In an exemplary embodiment, the credential may be, for example, a password, knowledge factor, pin code, biometric factor, etc., or a combination thereof. In an optional embodiment, the second device may be configured through the application to authenticate the user to the application before the application is accessed by the user. When the application is accessed by the user, the application may provide a user interface to the user. When the application is accessed by the user, the application may be configured to create a secure connection between the second device and the authentication server. In an optional embodiment, the application may be configured to receive a user input through the user interface. In an optional embodiment, the user input may be a selection of a remote system to connect. For example, the user may select the first device to access for remote connection. The selection of a device for connection may permit the system to connect to the correct authentication server and/or the first device, and/or the second device, and/or another server, and/or third device, and/or make the correct connections therebetween.

In an optional embodiment, the second device may be registered with the authentication server prior to the use of the application and the second device to remotely access the first device. The second device may be reauthenticated based on the registration of the second device at the time of remotely accessing the first device. The registration of the second device may include providing user credentials, device credentials, or other authentication information that may be stored at the authentication server. When making the secure connection between the second device and the authentication server, the user credentials, device credentials, or other authentication information may be sent from the second device to the authentication server to authenticate the device to the authentication server.

In an exemplary embodiment, the first device is remotely accessed by a third device. The third device is configured to communicate with the first device. In an exemplary embodiment, the third device is a computer device having a display and user input/output features, a processor, and memory. The third device is configured to receive the one time code from the first device. The third device may then be configured to display the one time code to the user. The user may then enter the one time code into the second device. In an exemplary embodiment, the one time code may be displayed on the third device as a QR code. In an exemplary embodiment, the second device may use its camera to take an image of the QR code on the third device. The second device may receive the one time code through the QR code. In an exemplary embodiment, the connection between the first and third device may be limited to provide the one time code. The first and third device may have a further connection once the user is authenticated through the process described herein. The further connection may be the user signing into the first device to provide full access to the first device from the third device. Other levels of access are also contemplated herein. The access level may permit access to certain programs of the first device, access to certain areas of a network to which the first device is connected, access to certain documents, memory, programs, etc. The access level may be limited based on an access level associated with the user and/or the first device and/or to the information and/or combinations thereof.

In an exemplary embodiment, the process described herein may include a process of remotely accessing a first device where: connecting the first device to an authentication server; generating a one time code that is displayed on a login screen; where the first device is being remotely accessed from a third device, accepting a code at the second device using an application stored on the second device configured to accept the one time code; modifying the first device to exclusively display the one time code using a credential provider that can authenticate a user or other device to the first device; receiving and verifying the one-time code with the authentication server from the second device and verifying the authentication of the user of the second device; transmitting approval for authentication of the user by the authentication server to the first device; and upon receiving the approval for authentication, signing the user into the first device.

Exemplary embodiments of the process may also include different combinations of additional features and/or steps. For example, the application on the second device may only be used when a registered user is authenticated to the second device, and/or where the second device is previously registered with the authentication server. The process may also include displaying the one-time code on the third device from a connection to the first device. The process may also include displaying the one-time code on the first device. The display of the one-time code may be a QR code. Accepting the one time code at the second device may include entering the code in a user interface of the second device generated by the application on the second device. Accepting the one time code may be through taking an image of the QR code and extracting the one-time code from information received from the QR code using the application on the second device.

Other configurations of receiving the one time code at the second device are also contemplated herein. For example, a wired or wireless connection may be created between the second device and the first device. For example, the second device may be coupled to the first device through Bluetooth, near field communication (NFC), Wi-Fi, etc. The one time code may be transmitted to the second device from the first device through the wired or wireless communication between the devices. The one time code may also be typed by the user in a user interface of the second device. The one time code may also be received in other configurations, such as other visuals, gestures, user inputs, etc.

An optional exemplary embodiment, the one-time code may be displayed as a QR code on a display screen on the device being used to access the first device. The one-time code may be transmitted to the authentication server by the second device. The second device may be configured through the application to receive, read, and/or process an image of the QR code, and process the information contained in the QR code and/or determine the one-time code from the QR code.

Using exemplary systems to employ the methods described herein that incorporate registry key modification, access to local and remote machines can be limited to a single credential provider that is installed to handle the specific remote authentication process or to other credential providers. In an exemplary embodiment, the exclusive use of the credential provider to send the one time code to the device of the user, such as the third device, is by modifying the registry keys of the operating system. In an exemplary embodiment, the first device is an electronic device running Microsoft Windows operating system. In an exemplary embodiment, the Microsoft Windows operating system comprises registry keys to set the authentication system used to authenticate a user to the first device. In an exemplary embodiment, at least one option of authentication to the first device is through WindowsMFA. The WindowsMFA authentication is used to authenticate the user to the device when the user authenticates to the device from the first device without remote access. The processes described herein permits the WindowsMFA to be replaced by another authentication system when a user is remotely accessing the first device. In an exemplary embodiment, the processes described herein may be used directly at the first device to provide additional or alternative authentication to the first device. In this case, the first device and the third device are the same device. The first device is therefore configured to display the user interface and provide the one-time code to the display.

By installing embodiments of the multi-factor authentication system described herein for remote access to a Windows machine protected by WindowsMFA, IT Administrators can facilitate stronger authentication standards for machine access, have an auditable log of when users sign into the machine and a consistent authentication method for desktop and web applications.

In an exemplary embodiment, the process described herein may include a process of remotely accessing a first device where: connecting the first device to an authentication server; generating a one time code that is displayed on a login screen; where the first device is being remotely accessed from a third device, accepting a code at the second device using an application stored on the second device configured to accept the one time code; receiving and verifying the one-time code with the authentication server from the second device and verifying the authentication of the user of the second device; transmitting approval for authentication of the user by the authentication server to the first device; and upon receiving the approval for authentication, signing the user into the first device.

The exemplary embodiment may optionally generate the one time code as a visual display code, such as a QR code, bar code, or other visual display. In an optional configuration, the system may be configured to generate a login interface as a display of the one time code without an input for a user name and/or password. In an optional configuration, the log in display may be on the first device. In an optional configuration, the log in display may be on the third device in communication with the first device. The system may therefore be configured to reproduce all or a part of a log in display from the first device onto a third device for remote access to the first device, wherein the log in display comprises a visual comprising a log in code.

In an exemplary optional embodiment, the second and third devices may be the same device. The first device may be different than the third device.

In an exemplary embodiment, the approval for authentication of the user sent to the first device may comprise providing an encrypted password to the first device. The encrypted password for approval may be provided after verification of the one-time code and user authentication is confirmed by the authentication server.

In an exemplary embodiment, approval for authentication of the user comprises unlocking a virtual smart card on the first device with an encrypted PIN transmitted from the authentication server to the first device after an authentication response is returned by the authentication server to the first device. The unlocked certificate of the virtual smart card may be used to log into the first device.

FIG. 12 illustrates an exemplary embodiment in which a user desires to access a first device directly. The system uses an authentication server (fourth device) as described herein to confirm that access is permitted through information received from a second device, where each of the first, second, and fourth devices are separate electronic devices.

In an exemplary embodiment, the first device is not remote and instead of displaying the one time code on a third device as described with respect to FIG. 11, it is displayed on the screen of the first device, where the exclusive use of the credential provider to display the one time code and authenticate the user account of the first device is set up by modification of the registry keys of a Microsoft Windows operating system. The system described with respect to FIG. 12 may have features of the first, second, and fourth devices as described with respect to FIG. 11.

In an exemplary embodiment, the process described herein may include a process of accessing a first device where: connecting the first device to an authentication server; generating a one time code that is displayed on a login screen; accepting a code at the second device using an application stored on the second device configured to accept the one time code; modifying the first device to exclusively display the one time code using a credential provider that can authenticate a user or other device to the first device; receiving and verifying the one-time code with the authentication server from the second device and verifying the authentication of the user of the second device; transmitting approval for authentication of the user by the authentication server to the first device; and upon receiving the approval for authentication, signing the user into the first device.

Exemplary embodiments of the process may also include different combinations of additional features and/or steps. For example, the application on the second device may only be used when a registered user is authenticated to the second device, and/or where the second device is previously registered with the authentication server. The process may also include displaying the one-time code on the first device as a login display interface. The display of the one-time code may be a QR code, or other visual representation comprising the one time code. Accepting the one time code at the second device may include entering the code in a user interface of the second device generated by the application on the second device. Accepting the one time code may be through taking an image of the QR code and extracting the one-time code from information received from the QR code using the application on the second device.

An optional exemplary embodiment, the one-time code may be displayed as a QR code on a display screen on the first device. The one-time code may be transmitted to the authentication server by the second device. The second device may be configured through the application to receive, read, and/or process an image of the QR code, and process the information contained in the QR code and/or determine the one-time code from the QR code.

Other configurations of receiving the one time code at the second device are also contemplated herein. For example, a wired or wireless connection may be created between the second device and the first device. For example, the second device may be coupled to the first device through Bluetooth, near field communication (NFC), Wi-Fi, etc. The one time code may be transmitted to the second device from the third device through the wired or wireless communication between the devices. The one time code may also be typed by the user in a user interface of the second device. The one time code may also be received in other configurations, such as other visuals, gestures, user inputs, etc.

Using exemplary systems to employ the methods described herein that incorporate registry key modification, access to local machines can be limited to a single credential provider that is installed to handle the specific authentication process or to other credential providers. In an exemplary embodiment, the exclusive use of the credential provider to send the one time code to a login of the device to be accessed by a user (a first device) is by modifying the registry keys of the operating system. In an exemplary embodiment, the first device is an electronic device running Microsoft Windows operating system. In an exemplary embodiment, the Microsoft Windows operating system comprises registry keys to set the authentication system used to authenticate a user to the first device. In an exemplary embodiment, at least one option of authentication to the first device is through WindowsMFA. In an optional embodiment, the WindowsMFA authentication may be used to authenticate the user to the device when the user authenticates to the device from the first device without remote access and may be selected by the user for authentication. The processes described herein also or alternatively permits the WindowsMFA to be replaced by another authentication system when a user is accessing the first device. In an exemplary embodiment, the processes described herein may be used directly at the first device to provide additional or alternative authentication to the first device. The first device is therefore configured to display the user interface and provide the one-time code to the display.

In an exemplary embodiment, the exclusive use of the credential provider to send the one time code to the device of the user is by modifying the registry keys of the operating system. In an exemplary embodiment, the first device is an electronic device running Microsoft Windows operating system. In an exemplary embodiment, the Microsoft Windows operating system comprises registry keys to set the authentication system used to authenticate a user to the first device. In an exemplary embodiment, at least one option of authentication to the first device is through WindowsMFA. The processes described herein permits the WindowsMFA to be replaced by another authentication system to provide different or additional security to the login process.

In an exemplary embodiment, the approval for authentication of the user sent to the first device may comprise providing an encrypted password to the first device. The encrypted password for approval may be provided after verification of the one-time code and user authentication is confirmed by the authentication server.

In an exemplary embodiment, approval for authentication of the user comprises unlocking a virtual smart card on the first device with an encrypted PIN transmitted from the authentication server to the first device after an authentication response is returned by the authentication server to the first device. The unlocked certificate of the virtual smart card may be used to log into the first device.

Exemplary embodiments described herein may provide additional security for accessing a Microsoft Machine.

By installing embodiments of the multi-factor authentication system described herein for remote or direct access to a Windows machine protected by WindowsMFA, IT Administrators can facilitate stronger authentication standards for machine access, have an auditable log of when users sign into the machine and a consistent authentication method for desktop and web applications.

By installing embodiments of the multi-factor authentication system described herein, remote access to a Windows machine may be provided to a Windows machine.

Exemplary embodiments described herein may provide systems and processes for providing multi-factor authentication to a Windows machine used in combination or in place of WindowsMFA. Exemplary embodiments may therefore be used to provide alternative or improved authentication to a Windows machine, either for direct log in or remote access through another electronic device.

Using exemplary systems to employ the methods described herein that incorporate registry key modification, access to local and remote machines can be limited to a single credential provider that is installed to handle the specific remote authentication process or to other credential providers.

Using exemplary systems to employ the methods described herein that incorporate registry key modification, access to local and remote machines can be limited to a single credential provider that is installed to handle the specific remote authentication process or to other credential providers.

Exemplary embodiments of the system described herein can be based in software and/or hardware. While some specific embodiments of the invention have been shown the invention is not to be limited to these embodiments. For example, most functions performed by electronic hardware components may be duplicated by software emulation.

Thus, a software program written to accomplish those same functions may emulate the functionality of the hardware components in input-output circuitry. The invention is to be understood as not limited by the specific embodiments described herein, but only by scope of the appended claims.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of accessing an electronic device that is not connected to an authentication server by a user authentication by a multi-factor authentication using a mobile device as one factor and by either authenticating to the mobile device with a biometric or with knowledge as the second factor, the method comprising:
transferring an encrypted code to the mobile device from the electronic device without using an authentication server;
decrypting by the mobile device the encrypted code to create a decrypted code;
transferring the decrypted code from the mobile device to the electronic device;
using the decrypted code to decrypt an encrypted credential on the electronic device to create a decrypted credential; and
allowing access to the electronic device by the user with the decrypted credential.

2. The method of claim 1, where a symmetric key is used to encrypt the credential such as a pin or password on the electronic device used to authenticate to the electronic device.

3. The method of claim 2, wherein a segment of the symmetric key is encrypted on the electronic device using a public key transmitted from the user's mobile device.

4. The method of claim 3, wherein the public key is transmitted from the user's mobile device through an authentication server during an online authentication session.

5. The method of claim 3, where the public key of the mobile device is transmitted to the electronic device via Bluetooth, near field technology or manual entry.

6. The method of claim 2, where the encrypted code is created using ECEIS and symmetric cryptography using a shared secret key created by using the private key of a key pair created on the electronic device.

7. The method of claim 6, wherein the key pair for creating the shared secret is created at the time of the offline authentication request.

8. The method of claim 1, wherein the key pair for creating the shared secret is from a key pair securely stored on the electronic device.

9. The method of claim 1, wherein the encrypted code is decrypted using a private key stored securely on the user mobile device.

10. The method of claim 1, wherein the encrypted code is transferred to the mobile device by means of a QR code.

11. The method of claim 1, wherein the encrypted code is transferred to the user mobile device electronically.

12. The method of claim 7, wherein Bluetooth or near field technology are used to transfer the encrypted code.

13. The method of claim 1, wherein the encrypted code is decrypted on the user's mobile device and visually displayed on the user's mobile device and transferred to the electronic device by means of a keyboard.

14. The method of claim 1, wherein the encrypted code is decrypted on the user's mobile device and electronically transferred to the electronic device.

15. The method of claim 14, wherein Bluetooth or near field technology are used to transfer the encrypted code.

16. The method of claim 13 wherein the decrypted code is used on the electronic device to recreate the symmetric key originally used to encrypt the token.

17. The method of claim 16 wherein the encrypted token is decrypted with the symmetric key and used to log into the electronic device.

18. The method of claim 1 wherein the mobile device can detect if the electronic device being accessed is offline based on the data transferred to the mobile device during a login attempt.

19. The method of claim 18 wherein the mobile device processes the transferred data and determines if it is to be used for online of offline use.

20. The method of claim 1 wherein the mobile device does not have an online connection.

21. The method of claim 1 where before encrypting the string of key segment bytes displayed on the first electronic device, the key segment string is created by concatenating the set of bytes removed from the symmetric key with placeholders inserted to buffer the bytes so that when the key segment string is decrypted and returned to the electronic device, it can be properly parsed.

22. The method of claim 20 where after the decrypted string is entered into the first electronic device, the buffer placeholders are removed to obtain the original bytes to recreate the symmetric key used to decrypt the encrypted, protected token.

23. The method of claim 1, wherein the encrypted code is changed after a successful log in to the first electronic device.
